(19) United States
(12) Patent Application Publication
(10) Pub. No.: US 2024/0097158 A1
(43) Pub. Date: Mar. 21, 2024

(54) BATTERY ARRANGEMENT WITH AN AIR SUPPLY DEVICE, MOTOR VEHICLE AND METHOD FOR OPERATING AN AIR SUPPLY DEVICE

(71) Applicant: AUDI AG, Ingolstadt (DE)

(72) Inventors: Oliver SCHIELER, Gaimersheim (DE); Markus THURMEIER, Adlkofen (DE)

(73) Assignee: AUDI AG, Ingolstadt (DE)

(21) Appl. No.: 18/446,781

(22) Filed: Aug. 9, 2023

(30) Foreign Application Priority Data
Sep. 15, 2022 (DE) 102022123573.4

(51) Int. Cl. H01M 8/04089; H01M 8/0662; H01M 10/02; H01M 50/204; H01M 50/249

(52) U.S. Cl. CPC H01M 8/04089; H01M 8/0662; H01M 10/02; H01M 50/204; H01M 50/249; H01M 2220/20; H01M 2250/20

(57) ABSTRACT

A battery arrangement with an air supply device. The battery arrangement has a housing, at least one battery unit arranged in the housing at least one battery cell, and an air supply line as part of the air supply device. The air supply line is fluidically connected to the housing in order to supply air to the housing via the air supply line. In particular, the air supply device has a control device which is designed to control the supply of air into the housing depending on the at least one battery unit.

### FIELD

The invention relates to a battery arrangement with an air supply device, wherein the battery arrangement has a housing, at least one battery unit arranged in the housing and comprising at least one battery cell, and an air supply line as part of the air supply device, wherein the air supply line is fluidically connected to the housing in order to supply air to the housing via the air supply line. Furthermore, the invention also relates to a motor vehicle and a method for operating an air supply device.

### BACKGROUND

In the case of battery systems for electric vehicles, there is a constant striving to increase the range or power density of such battery systems. For this purpose, an attempt is usually made to accommodate as many battery cells as possible in a motor vehicle. However, there are limits due to the installation space.

An air supply device for a battery is also known from DE 10 2013 200 782 A1. In this case, a housing of a battery is designed so that air can flow through it in order to avoid the formation of condensate on the battery. A control device can control the air supply to the housing. The control can be dependent on the humidity of the air that can be supplied.

This may extend battery life, but will not increase battery range or performance.

### SUMMARY

It is therefore the object of the present invention to provide a battery arrangement, a motor vehicle and a method which make it possible to create the prerequisites for providing a battery with the highest possible energy density or power density.

This object is achieved by a battery arrangement, a motor vehicle and a method with the features according to the respective independent claims. Advantageous embodiments of the invention are the subject matter of the dependent claims, the description, and the figures.

The invention relates to a battery arrangement with an air supply device, wherein the battery arrangement has a housing, at least one battery unit arranged in the housing and comprising at least one battery cell, and an air supply line as part of the air supply device, wherein the air supply line is fluidically connected to the housing in order to supply air to the housing via the air supply line. In this case, the air supply device has a control device which is designed to control the supply of air into the housing depending on the at least one battery unit.

The invention is based on the knowledge that there are battery cells, such as air battery cells or solid-state battery cells, which require air, for example, to be charged and discharged, wherein air serves as an activator. It is very advantageous if the air supplied, in particular the amount of air supplied, is adapted to a current state of the battery unit or its battery cells, since the air requirement of these battery cells can be dependent on their state, for example their operating state. The invention now uses these findings to provide an air supply device which is designed to control the supply of air into the housing depending on the at least one battery unit. In this way, the currently required air volume can always be made available to the battery unit in a sufficient manner. This creates the prerequisites for using, for example, one or more air battery cells or solid-state battery cells as the battery unit, as a result of which the energy density and/or power density of the battery arrangement can in turn be increased enormously. In addition, this allows a very efficient operation of such a battery unit and an increase in performance.

The battery unit can be, for example, a single battery cell or a battery module with multiple battery cells. One or more such battery units can in turn be arranged in the housing. The housing can be, for example, an overall battery housing in which a number of battery modules are arranged, or it can also be a single module housing in which a number of individual battery cells are arranged. This module housing can then in turn be arranged in an overall battery housing, for example together with other correspondingly designed battery modules. In other words, the housing with the battery unit arranged therein can represent a module housing of a battery module or also an overall battery housing, which is sometimes simply referred to below as the battery housing, and in which a number of battery modules, each with a number of battery cells and corresponding module housings, are arranged accordingly. The air can be guided by means of the air supply device either into an overall battery housing or also directly into an individual module housing, in particular into the respective module housing of respective battery modules of a battery of the battery arrangement. A separate air supply line can be provided for each battery module, or the air supply line can be part of a branching air supply line system, with each battery module being able to be assigned a line branch. If the housing is the overall battery housing in which a plurality of battery modules are arranged, the air supply line can be provided as a single and sole air supply line in order to supply air to the overall battery housing.

The battery can be designed in particular as a high-voltage battery. It is further preferred that the housing is watertight. The air supply device can be positioned accordingly and/or provided with protective measures in order to prevent water or moisture from penetrating into the housing via the air supply device.

The air that is or can be supplied to the housing via the air supply device originates from the surroundings, in particular of the motor vehicle. This has the advantage that no air tank or the like has to be carried along. The air supply line can be designed, for example, as a tube and/or a hose, via which the air can be supplied to the housing. A first end of such an air supply line can therefore be correspondingly coupled to the housing and a second end opens out, for example, into the surroundings of the motor vehicle, in particular directly or indirectly, possibly also with interruptions. For example, the air can also be routed into the housing via the vehicle interior, wherein the air in the vehicle interior ultimately also comes from the surrounding environment and is fed to the vehicle interior via a ventilation system or air conditioning system of the motor vehicle, for example, as will be explained in more detail later.

The air supply device can also have an air conveying device, for example, in order to actively convey air in the direction of the housing. The control device can be designed accordingly to activate this air conveying device in order to control the supply of air. Such an air conveying device can be designed, for example, as a ventilator or fan or blower or the like. Such an air conveying device can be arranged, for example, in the air supply line or at any other location. Furthermore, it is advantageous, as will be explained in more detail later, if a possibility for air discharge from the housing is also provided, for example in the form of a corresponding air discharge device. Such an air conveying device can also be arranged in such an air discharge device, which can also be designed, for example, as a type of line from the housing into the surroundings or the interior of the motor vehicle.

It is particularly advantageous if the control device is designed to control the supply of air into the housing, in particular an air mass flow, depending on a state of the at least one battery unit, in particular depending on an operating state and/or a charging power or discharging power and/or depending on a state of charge of the battery unit. As already mentioned above, air battery cells or solid-state battery cells, for example, require more or less air, for example depending on whether they are currently being charged or discharged, are not currently in operation or also depending on their state of charge or other states, for example an aging state. It is therefore very advantageous if the air mass flow of the air supplied is controlled depending on the current state of the battery unit. In this way, the optimal amount of air can always be made available to the battery unit, in particular for the operation of the battery unit.

It is also very advantageous if the at least one operating state represents at least one of the following: a charging state in which the battery unit is electrically charged, a discharged state in which the battery unit is discharged, and an inactive state in which the battery unit is not in operation. In the inactive state of the battery unit, it accordingly does not require any air. Accordingly, the air supply to the housing can be prevented in the inactive state. If the battery unit is currently being charged or discharged, the air supply, in particular the air mass flow that is supplied, can also be additionally controlled depending on the current charging power. This enables even better adaptation to the situation and optimized operation of the battery unit.

In the event that the battery arrangement is designed in such a way that air can be supplied separately to several different battery units of the battery arrangement, for example if air can be supplied separately to individual housings of the several battery units via separate air supply devices, the air mass flow can also be controlled depending on the respective states of the respective battery units. In other words, module-specific control of the air mass flow is conceivable, and under certain circumstances even cell-specific control of the air mass flow. However, it is also conceivable that all battery cells of the battery included in the battery arrangement, which can comprise one or more battery units, can only be provided with a single air mass flow which is correspondingly used by all battery cells included in the battery arrangement. This air mass flow can then be controlled, for example, depending on an averaged state variable of the battery cells, for example if the individual states of the battery cells, for example their respective charging states, capacities or aging states, differ somewhat.

In a further advantageous embodiment of the invention, the at least one battery cell is designed as an air battery cell, to which in particular the air introduced into the housing by means of the air supply device can be supplied as an oxidizer, and/or the at least one battery cell is designed as a solid-state battery cell. There are also solid-state battery cells that represent air battery cells at the same time. For both battery cell types, it is very advantageous to provide a controllable air supply device, by means of which the air mass flow can be adjusted depending on the state of the battery cells. The total energy content of a battery in the battery arrangement, in particular of a high-voltage battery, can be increased enormously precisely through these two battery cell types, in particular given a specific installation space.

Furthermore, it is very advantageous if, as is provided according to a further advantageous embodiment of the invention, the air supply device has a cleaning device which is designed to clean the air before it is fed to the housing, and in particular to free it of electrically conductive particles. The cleaning device can have a separating unit, for example, by means of which particles, dirt, in particular electrically conductive particles, or the like can be separated from the air. Such a separating device can, for example, have a corresponding filter or the like. This advantageously prevents dirt or electrically conductive particles from getting into the interior of the housing. This reduces the risk of short circuits, especially since the supplied air is used to operate the battery cells and, for example, can also come into direct contact with the battery cells or the interior of the battery cells in order to act as an oxidizer or activator.

The cleaning device can be arranged in the flow path provided by the air supply device. In particular, the cleaning device can be arranged at any point in the air supply line mentioned above. In addition, it is also conceivable that the cleaning device is designed to carry out air dehumidification. Components of an air conditioning system already present in the vehicle can also be used for this purpose. This can advantageously prevent moisture from getting into the interior of the housing.

In a further advantageous embodiment of the invention, the battery arrangement has an air discharge device which is connected to the housing and via which at least part of the supplied air can be discharged from the housing. This can also be designed, for example, as a line or the like. A first end of this line can in turn be connected to the housing and another end of the line can, for example, open into the surroundings of the motor vehicle or be coupled in an interior of the motor vehicle or at any location to a ventilation system of the motor vehicle. By providing such an air discharge device, an overpressure in the housing can advantageously be avoided. In addition, the housing is preferably designed to be airtight, with the exception of a first connection point to the air supply device and a second connection point to the air discharge device. The interior of the housing is therefore still protected to the maximum, in particular against contamination or the penetration of liquids or the like.

In a further advantageous embodiment of the invention, the air discharge device has a protective device which is designed to prevent air from penetrating through the air discharge device into the housing. Such a protective device can be designed, for example, in the form of a flap or membrane, a valve or the like. For example, the protective device can be designed in such a way that air can escape from the housing into the surroundings, while the inverse air path is blocked. The protective device can also be designed in such a way that the air to be discharged from the housing can only escape above a certain minimum pressure, above which the protective device opens and releases the fluidic connection to the surroundings. If the pressure falls below this minimum again, the protective device closes again. As a result, the protection of the interior of the housing can be increased further. The system can thus be designed to be particularly tight and it can be ensured that no air, in particular no uncleaned air, can flow in from the outside.

Furthermore, the invention also relates to a motor vehicle with a battery arrangement according to the invention or one of its embodiments. The advantages mentioned for the battery arrangement according to the invention and its embodiments thus apply similarly to the motor vehicle according to the invention.

In a further advantageous embodiment of the invention, the air supply device is designed to direct the air from an interior of the motor vehicle and/or from a ventilation system for ventilating the interior into the housing. This has the advantage that the air supply device can be protected from environmental influences in a much better and simpler way. The air line can, so to speak, lead from the interior of the motor vehicle into the housing. The interior of the motor vehicle is in turn exposed to significantly fewer environmental influences than the surroundings of the motor vehicle. In addition, the air originating from the ventilation system, which is supplied to the interior of the motor vehicle for ventilation, in particular from the surroundings, is already pre-cleaned. In other words, such a ventilation system also has a cleaning device, for example in the form of particle filters or the like, by means of which the air can already be pre-cleaned. This makes it possible to provide the housing with an even more efficient air cleaning. The air can also be discharged via the interior of the motor vehicle and/or the ventilation system. Thus, for example, the air discharged from the housing can flow into the ventilation system or the air management system of the vehicle, in order to circulate the air there and mix it with fresh outside air, in order to then, for example, in turn feed it to the housing via the air supply device.

According to a further advantageous embodiment of the invention, the air supply device is designed to direct the air from an area surrounding the motor vehicle into the housing without flowing through a ventilation system for ventilating an interior of the motor vehicle. In other words, the air from the surroundings of the motor vehicle can also be introduced directly into the housing via the air supply device, in particular with optional prior cleaning by the cleaning device described above. The air supply to the housing is thus advantageously independent of the operation of the ventilation system for ventilating the interior of the motor vehicle. As a result, for example, air recirculation mode of the ventilation system does not impair the air quality in the interior of the motor vehicle. The air can in turn also be discharged directly into the surroundings, namely without being routed via the interior of the motor vehicle and/or the ventilation system of the motor vehicle. These variants of the air supply and air discharge can also be combined with one another in any suitable way.

In both cases, the air is drawn from the surroundings, in particular directly or indirectly. The interface between the motor vehicle and the surroundings, in order to draw air from it or discharge it into the surroundings, is preferably positioned at a sufficiently high point on the motor vehicle to ensure that no liquid can get into the housing via the air supply or discharge device. The outlet points of the air supply or air discharge device can be arranged, for example, above a wading depth of the motor vehicle. In addition, the discharge points can be closed by flaps, valves, closures or other protective devices when not in use, namely when no air is to be supplied to the housing. In addition, these outlet points are preferably arranged at a particularly protected location on the motor vehicle, so that no spray water or rainwater or the like can get into the air supply device and/or air discharge device or at least cannot get into the housing even during operation. For example, the air supply device can also be designed, for example, with a line that has a siphon-like course, so that liquid that has gotten into this line from the outside cannot get any further into the housing due to the force of gravity. In addition, the air supply device and also the air discharge device can be designed with moisture or liquid sensors in order to further increase safety. In the event that excessive moisture or liquid is detected, a warning message can be issued or the system can be switched off.

The motor vehicle according to the invention is preferably designed as an automobile, in particular as a passenger car or truck, or as a passenger bus or motorcycle.

Furthermore, the invention also relates to a method for operating an air supply device for a battery arrangement, which has a housing, at least one battery unit arranged in the housing and comprises at least one battery cell, and an air supply line as part of the air supply device, via which air is supplied to the housing. In this case, the air supply device has a control device which is designed to control the supply of air into the housing depending on the at least one battery unit.

The advantages mentioned in conjunction with the battery arrangement according to the invention and its embodiments also apply in this case, as are also the advantages cited in relation to the motor vehicle according to the invention and its embodiments for the method according to the invention.

The invention also includes further developments of the method according to the invention, which have features as already described in the context of the further developments of the battery arrangement according to the invention and the motor vehicle according to the invention. For this reason, the corresponding developments of the method according to the invention are not described again here.

The invention also comprises the control device for the motor vehicle. The control device can have a data processing device or a processor device which is set up to perform an embodiment of the method according to the invention. For this purpose, the processor device can have at least one microprocessor and/or at least one microcontroller and/or at least one FPGA (Field Programmable Gate Array) and/or at least one DSP (Digital Signal Processor). The processor device can also have program code, which is provided to perform an embodiment of the method according to the invention, when it is executed by the processor device. The program code can be stored in a data memory of the processor device. A processor circuit of the processor device can have, for example, at least one circuit board and/or at least one SoC (System on Chip).

The invention also comprises the combinations of the features of the described embodiments. The invention also includes implementations that each have a combination of the features of several of the described embodiments, unless the embodiments were described as mutually exclusive.

### BRIEF DESCRIPTION OF THE FIGURES

Exemplary embodiments of the invention are described hereinafter. In particular:

FIG. 1 shows a schematic representation of a motor vehicle with a battery arrangement according to a first exemplary embodiment of the invention; and

FIG. 2 shows a schematic representation of a motor vehicle with a battery arrangement according to a second exemplary embodiment of the invention.

### DETAILED DESCRIPTION

The exemplary embodiments explained hereinafter are preferred embodiments of the invention. In the exemplary embodiments, the described components of the embodiments each represent individual features of the invention to be considered independently of one another, which each also develop the invention independently of one another. Therefore, the disclosure is also intended to comprise combinations of the features of the embodiments other than those represented. Furthermore, the described embodiments can also be supplemented by further ones of the above-described features of the invention.

In the figures, same reference numerals respectively designate elements that have the same function.

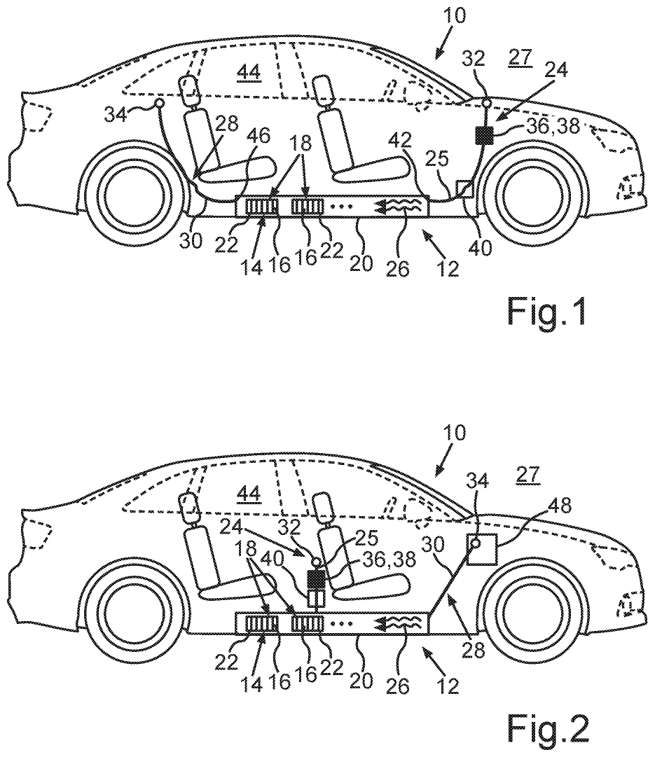

FIG. 1 shows a schematic representation of a motor vehicle 10 having a battery arrangement 12 according to a first exemplary embodiment of the invention. The battery arrangement 12 has a battery 14 which is designed as a high-voltage battery 14 in this example. The battery 14 in turn comprises a plurality of battery cells 16 which in turn can be combined into battery modules 18. In addition, the battery 14 has a battery housing 20 in which the battery cells 16, in particular the battery modules 18, are arranged. The battery modules 18 can also each have their own module housing 22. The aforementioned battery unit can be a single battery cell 16 as well as an entire battery module 18 with a plurality of battery cells 16. Accordingly, in general, the aforementioned housing can be the overall battery housing 20 or also an individual module housing 22.

The battery arrangement 12 now also has an air supply device 24 via which air 26 from the surroundings 27 can be supplied to the battery housing 20. For this purpose, the air supply device 24 can comprise an air supply line 25. This is connected to the battery housing 20 in the present example. Furthermore, the battery arrangement 12 also comprises an air discharge device 28 with a corresponding air discharge line 30, via which excess air 26 or portions thereof can be fed back into the surroundings 27. Accordingly, the air supply device 24 can provide an air inlet 32 and the air discharge device 28 can provide a corresponding outlet 34.

The battery cells 16 can also be designed as air battery cells and/or solid-state battery cells. As a result, the energy density in the vehicle 10 can be significantly increased. Air battery cells and in particular also solid-state battery cells require air 26, in particular air that is as clean as possible, in order to be charged and discharged since pure air is used as an activator. The air requirement is also partly dependent on the state of the battery cells 16, for example on whether they are currently being charged, charged quickly, namely charged with high charging power, the vehicle 10 is being driven and the cells 16 are therefore in the active state, and so on. The air requirement can also be dependent on the extension of the battery cells 16. It is therefore particularly advantageous for the air supply device 24 to have a mass flow regulator 36, which can include a control device 38, for example, which is designed to regulate the air flow 26 supplied to the housing 20, in particular depending on the current state of the battery cells 16 or the battery modules 18, for example the current state of charge or operating state or age, and so on. An adapted amount of air 26 can thus always be supplied to the cells 16. The mass flow regulator 36 can, for example, also have a blower or the like that can be controlled by the control device 38 in order to actively draw in air 26 from the surroundings 27 via the inlet 32 and convey it into the housing 20. In general, therefore, a conveying unit is preferably also arranged in the air supply line 25 or in the hose system comprising the same, which regulates the air mass flow and adapts it to the current battery state and which can accordingly be referred to as mass flow regulator 36.

Furthermore, the air supply device 24, in particular in the air supply line 25, has an air cleaning system 40 which is designed to clean the air 26 before it is supplied to the housing 20. This air cleaning system 40 can also have a separator, for example. Thus, mainly particles, dirt, especially electrically conductive particles, can be filtered out from the air drawn in through the inlet 32. The cleaning device or the cleaning system 40 can also be designed to reduce the humidity of the air 26 supplied. In general, cleaning systems, filters or separation systems can be contained in the air supply line 25 or in the hose or pipe system comprising the same, in order to get the air into a defined state.

Thus, advantageously, a battery housing 20 or optionally also a closed module housing 22 of a module 18 can be provided, which has access to outside air, which is provided via a hose system, for example, in this example the air supply line 25. The air supply device 24 and the discharge device 28 can be part of an air supply system of the battery arrangement 12. The supply system, in particular the air supply device 24 and/or the air discharge device 28, can be made of plastic material and in particular can be made of plastic in a fully integrated manner, in particular as a one-piece component. The cleaning unit 40 can also be integrated into the supply device 24. The battery housing 20 can otherwise be of closed design, just like a corresponding module housing 22, and correspondingly have two defined openings 42, 46, one for the supply line 25 and one for the discharge line 30. These connections 42, 46 on the housing 20 are also preferably designed to be airtight and/or watertight, namely sealed to the outside, so that no water or air can penetrate the housing 20 from outside the corresponding lines at this connection point. This is particularly advantageous when the battery housing 20 is located below the wading depth of the motor vehicle 10.

In this example, the air can be discharged outside of the motor vehicle 10 directly into the surroundings 27. It is also advantageous if the system, namely the battery arrangement 12, is likewise sealed or protected in order to prevent contaminated air from outside, namely from the surroundings 27, from entering the housing 20 via the discharge device 28. This can be implemented, for example, by means of flaps or membranes, for example in or on the air discharge line 30, which only open at a certain minimum pressure, and only if this minimum pressure originates from inside the battery housing 20 and not from the surroundings 27. However, it is also conceivable for the air to be supplied and discharged not directly to the surroundings 27, but rather indirectly via the interior of the vehicle 10, as will be explained in more detail below.

FIG. 2 shows a schematic representation of a motor vehicle 10 with a battery arrangement 12 according to a further exemplary embodiment of the invention. The motor vehicle 10 and the battery arrangement 12 can be designed as described above, with the exception of the differences described below: In this example, the air inlet is fluidically connected to the interior 44 of the motor vehicle 10. In other words, the air is fed from the interior 44 into the housing 20 via the supply device 24. In this example, the derivation takes place via the air management system or the ventilation system 48 of the motor vehicle 10. This can also comprise an air conditioning system of the vehicle. For this purpose, the outlet 34 is correspondingly coupled to this air management system 48 and does not open directly into the surroundings 27 of the motor vehicle 10. As a result, the inlet and outlet 32, 34 are significantly better protected against environmental influences. The air can flow out, for example, directly into the air management system 48 of the vehicle 10 in order to circulate the air there and to mix it with fresh outside air from the surroundings 27. This can then in turn be supplied to the supply device 24 via the interior 44 and fed to the housing 20 accordingly. The air discharge into the central air supply system 48 of a vehicle 10, in particular into the air conditioning system 48 of the vehicle 10, or into the interior 44, thus represents a further possibility for discharging the air out of the housing 20 again. The discharged air can be mixed with the fresh new outside air coming from the surroundings 27 which is supplied to the interior 44 via this air conditioning system 48.

The air can also be fed into the battery housing 20 either directly, as described with reference to FIG. 1, or indirectly from the interior 44 of the vehicle 10 into the battery housing 20. In particular, the air in the interior 44 represents pre-cleaned interior air. This is additionally cleaned again by the cleaning system 40 before it is fed to the housing 20.

Overall, the examples show how a switched air supply system for battery housings is provided by the invention.

1. A battery arrangement with an air supply device, comprising
a housing;
at least one battery unit arranged in the housing and comprising at least one battery cell;
an air supply line as part of the air supply device, wherein the air supply line is fluidically connected to the housing in order to supply air to the housing via the air supply line;
wherein the air supply device has a control device which is designed to control the supply of air into the housing depending on the at least one battery unit.

2. The battery arrangement according to claim 1, wherein the control device is designed to control the supply of air into the housing, in particular an air mass flow, depending on a state of the at least one battery unit, in particular depending on an operating state and/or a charging power or discharging power and/or depending on a state of charge of the battery unit.

3. The battery arrangement according to claim 1, wherein the at least one battery cell is designed as an air battery cell to which the air introduced into the housing by means of the air supply device can be supplied as an oxidizer and/or the at least one battery cell is designed as a solid-state battery cell.

4. The battery arrangement according to claim 1, wherein the air supply device has a cleaning device which is designed to clean the air before it is fed to the housing, in particular to clean it of electrically conductive particles.

5. The battery arrangement according to claim 1, further comprising an air discharge device connected to the housing, via which at least part of the supplied air can be discharged from the housing.

6. The battery arrangement according to claim 1, wherein the air discharge device has a protective device which is designed to prevent air from penetrating through the air discharge device into the housing.

7. A motor vehicle with a battery arrangement according to claim 1.

8. The motor vehicle according to claim 7, wherein the air supply device is designed to supply air from an interior of the motor vehicle and/or from a ventilation system for ventilating the interior into the housing.

9. The motor vehicle according to claim 7, wherein the air supply device is designed to feed the air from the surroundings of the motor vehicle into the housing without it flowing through a ventilation system for ventilating an interior of the motor vehicle.

10. A method for operating an air supply device for a battery arrangement, which comprises a housing, at least one battery unit arranged in the housing and comprising at least one battery cell, and an air supply line as part of the air supply device, via which air is supplied to the housing; wherein the air supply device has a control device which is designed to control the supply of air into the housing depending on the at least one battery unit.

11. The battery arrangement according to claim 2, wherein the at least one battery cell is designed as an air battery cell to which the air introduced into the housing by means of the air supply device can be supplied as an oxidizer and/or the at least one battery cell is designed as a solid-state battery cell.

12. The battery arrangement according to claim 2, wherein the air supply device has a cleaning device which is designed to clean the air before it is fed to the housing, in particular to clean it of electrically conductive particles.

13. The battery arrangement according to claim 3, wherein the air supply device has a cleaning device which is designed to clean the air before it is fed to the housing, in particular to clean it of electrically conductive particles.

14. The battery arrangement according to claim 2, further comprising an air discharge device connected to the housing, via which at least part of the supplied air can be discharged from the housing.

15. The battery arrangement according to claim 3, further comprising an air discharge device connected to the housing, via which at least part of the supplied air can be discharged from the housing.

16. The battery arrangement according to claim 4, further comprising an air discharge device connected to the housing, via which at least part of the supplied air can be discharged from the housing.
